(19) United States
(12) Patent Application Publication
(10) Pub. No.: US 2023/0195489 A1
(43) Pub. Date: Jun. 22, 2023

(54) PLUGGABLE DIAGNOSTIC TOOL FOR TELCO RAN TROUBLESHOOTING

(71) Applicant: VMware Inc., Palo Alto, CA (US)

(72) Inventors: Jian Lan, Beijing (CN); Liang Cui, Beijing (CN); Aravind Srinivasan, Sunnyvale, CA (US); Todd Sabin, Morganville, NJ (US); Uday Suresh Masurekar, Sunnyvale, CA (US); Weiqing Wu, Cupertino, CA (US)

(21) Appl. No.: 17/583,148

(22) Filed: Jan. 24, 2022

(30) Foreign Application Priority Data
Dec. 21, 2021 (WO) PCT/CN2021/139943

(51) Int. Cl. G06F 9/455; H04W 84/02

(52) U.S. Cl. CPC G06F 9/45558; H04W 84/02; G06F 2009/4557; G06F 2009/45579; G06F 2009/45595

(57) ABSTRACT

A computer-implemented method, medium, and system for implementing a pluggable diagnostic tool for Telco radio access network (RAN) troubleshooting are disclosed. In one computer-implemented method, one or more containerized network function (CNF) instances are generated in a container orchestration platform by a test system and by using a telecommunication cloud automation (TCA) platform executed in the container orchestration platform, where the test system is onboarded to the TCA platform, and the one or more CNF instances are associated with 5G RAN. A customer resources (CR) file is received by the test system, where the CR file defines multiple test cases associated with validation of the TCA platform. The CR file is transmitted to a cluster of nodes in the container orchestration platform. The validation of the TCA platform is executed at the cluster of nodes based on the one or more CNF instances and the CR file.

### TECHNICAL FIELD

The present disclosure relates to computer-implemented methods, medium, and systems for implementing pluggable diagnostic tool for telecommunications troubleshooting.

### BACKGROUND

Telecommunication (hereafter “Telco”) industry is transitioning as 5G business, container orchestration platform, and containerized network functions (CNFs) solutions are getting more attention and deployment. A container orchestration platform enables the automation of the operational effort required to run containerized workloads and services. This includes a wide range of things needed to manage a container’s lifecycle, including, but not limited to, provisioning, deployment, scaling (up and down), networking, and load balancing. A container orchestration platform can have multiple pods, with each pod representing a group of one or more application containers, as well as some shared resources for those containers. A container orchestration platform can host different container based platforms that support different functions. For example, a container based platform can be added to a container orchestration platform to support Telco radio access network (RAN) CNFs and to make sure that the Infra as a Service (IaaS) and Containers as a service (CaaS) platforms meet network functions’ (NFs′) requirements and achieve good performance per 5G standards. To achieve this goal, validation of platform application programming interface (API) contracts, infrastructure configuration such as resources and networks, infrastructure tuning such as basis input/output system (BIOS), hypervisor firmware, drivers, and applications, and performance validation is useful.

### SUMMARY

The present disclosure involves computer-implemented method, medium, and system for implementing a pluggable diagnostic tool for Telco radio access network (RAN) troubleshooting. One example computer-implemented method includes generating one or more containerized network function (CNF) instances in a container orchestration platform by a test system in the container orchestration platform and by using a telecommunication cloud automation (TCA) platform executed in the container orchestration platform, where the test system is onboarded to the TCA platform and performs validation of the TCA platform, and the one or more CNF instances are associated with 5G RAN. A customer resources (CR) file is received by the test system, where the CR file defines multiple test cases associated with validation of the TCA platform, and the multiple test cases include validation of features associated with infrastructure used by the TCA platform. The CR file is transmitted by the test system to a cluster of nodes in the container orchestration platform. The validation of the TCA platform is executed by the test system and at the cluster of nodes based on the one or more CNF instances and the CR file.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an environment architecture of an example computer-implemented system that can execute implementations of the present disclosure.

FIG. 2 illustrates an example system for implementing a pluggable diagnostic tool for Telco RAN troubleshooting, in accordance with an example implementation of this disclosure.

FIG. 3 illustrates an example sequencing diagram for implementing a pluggable diagnostic tool for Telco RAN troubleshooting, in accordance with another example implementation of this disclosure.

FIG. 4 illustrates an example network topology for implementing a pluggable diagnostic tool for Telco RAN troubleshooting, in accordance with a further example implementation of this disclosure.

FIG. 5 is a flowchart illustrating an example of a method for implementing a pluggable diagnostic tool for Telco RAN troubleshooting, in accordance with example implementations of this disclosure.

FIG. 6 is a schematic illustration of example computer systems that can be used to execute implementations of the present disclosure.

### DETAILED DESCRIPTION

Some existing strategies for validating a Telco 5G RAN CNF platform rely on running 5G vendors’ applications in the platform. Because the vendor applications do not have built-in functions to perform this type of validation, the validation is carried out manually. Such validation also lacks a defined set of measurements and cannot cover all platform/infrastructure features in different conditions. For validation of a 5G RAN CNF platform, there may be traffic across distributed units (DUs), central units (CUs) over single root input/output virtualization (SRIOV), accelerator card, and multi container network interface (CNI) network. Such traffic may complicate the validation, diagnosis, troubleshooting of the Telco 5G RAN CNF platform.

This disclosure describes technologies for implementing a pluggable diagnostic tool for Telco RAN troubleshooting. In some implementations, the tool provides plugins to validate Platform API contracts automatically. It delivers packages in the same fashion as normal CNFs, which are delivered in container images, cloud service archive (CSAR) files, and application configuration files (e.g., helm chart in Kubernetes). Several CSARs can be provided based on different scenarios to cover all platform/infrastructure features such as SRIOV, real-time (RT) kernel, packages, placement, non-uniform memory access (NUMA), CPU reservation, precision time protocol (PTP), and field programmable gate array (FPGA). Example scenarios include CSAR in RAN condition to simulate distributed unit (DU) condition, CSAR in edge data center (EDC) condition to simulate central unit (CU) / user plane function (UPF) condition, CSAR in regional data center (RDC) condition to simulate access and mobility management function (AMF) condition, and CSAR in national data center (NDC) condition to simulate control plane condition. Additionally, this tool can be deployed to automatically validate pod, node, virtual machine (VM), and host customization API contracts to utilize workflow steps executed after CNF instantiation.

In some implementations, the tool provides plugins to validate infrastructure configuration such as resources and networks automatically. For CNF in RAN, CPU and memory are reserved, CPU pinning is enabled in the same NUMA as well as in the other network devices such as SRIOV physical functions (PFs) and virtual functions (VFs), PTP, and FPGA. The tool also provides nodes in a container orchestration platform validation plugin to automatically validate the infrastructure configuration.

In some implementations, the tool provides plugins to validate infrastructure configuration such as resources and networks automatically. For CNF in RAN, CPU and memory are reserved, CPU pinning is enabled in the same NUMA as well as the other network devices such as SRIOV PFs/VFs, PTP, FPGA, etc. TestNF provides k8s node (TKG VM) validation plugin to automatically validate the infrastructure configuration.

In some implementations, the tool provides plugins to validate infrastructure tuning at cell site host level (such as BIOS customization, firmware and driver validation of accelerator cards), at node level (such as kernel arguments, CPU isolation, and huge page), at pod level (such as tuning CNI). For data plane development kit (DPDK) applications, the tool also provides plugins to validate infrastructure tuning.

In some implementations, the tool provides plugins to validate performance, such as traffic from pod to pod and from external test tool to pod.

In some implementations, the tool is extensible and pluggable. It provides declarative configuration model to define testbed, test case, benchmark, and diagnostic. A set of custom resource definitions (CRDs) is defined to describe the job to be performed by the tool and automate the job.

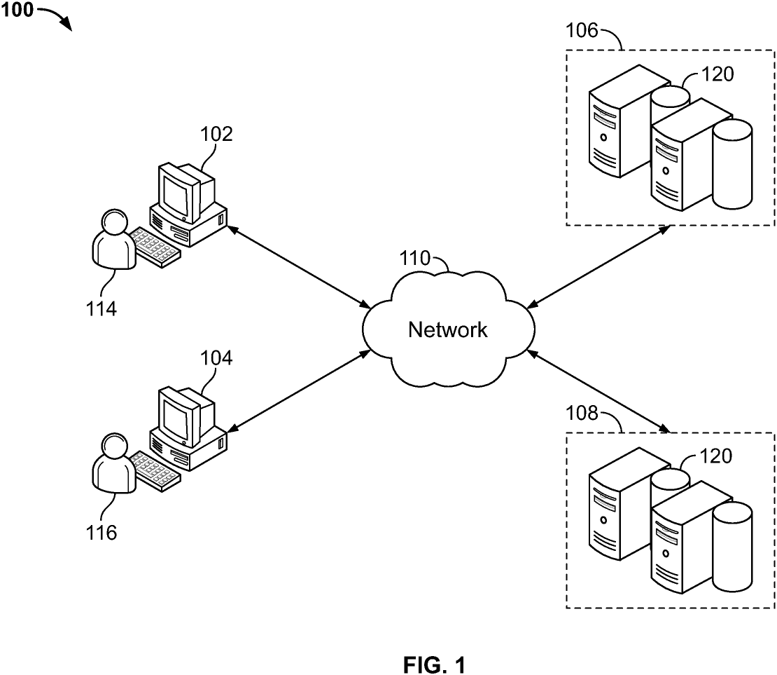

FIG. 1 depicts an environment architecture of an example computer-implemented system 100 that can execute implementations of the present disclosure. In the depicted example, the example system 100 includes a client device 102, a client device 104, a network 110, and a cloud environment 106 and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the cloud environment 106 include at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

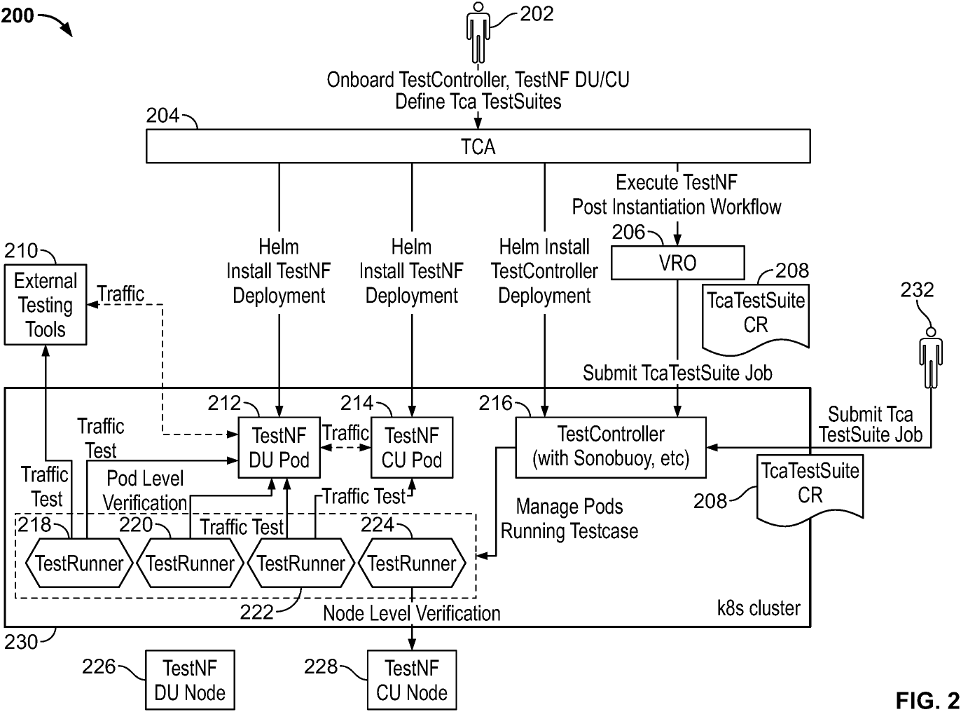

FIGS. 2 to 4 illustrate example systems for implementing a pluggable diagnostic tool for Telco RAN troubleshooting, in accordance with example implementations of this disclosure. Every component shown and described in FIGS. 2 to 4 can be implemented as a computer system that executes computer instructions stored on a computer-readable medium.

FIG. 2 illustrates an example system 200 for implementing a pluggable diagnostic tool for Telco RAN troubleshooting, in accordance with an example implementation of this disclosure. It shows an example framework of using a test system TestNF to test platform/infrastructure features of a telecommunication (Telco) cloud automation (TCA) platform, at pod level and node level, as well as traffic between different pods and between pods and external testing tools.

In some implementations, TestNF related data, such as CSAR files, application configuration files (e.g., helm chart in Kubernetes), and container images, are downloaded to TCA platform 204, TestController 216 is onboarded to TCA platform 204, and network function (NF) instances, such as TestNF distributed unit (DU) pod 212 and TestNF central unit (CU) pod 214, are created by the example test system TestNF. TCA platform 204 can be used to generate TestNF DU pod 212 in a DU node pool of a container orchestration platform such as Kubernetes (k8s), as well as TestNF CU pod 214 in a CU node pool of the container orchestration platform. An example of the DU node pool is TestNF DU node 226, and an example of the CU node pool is TestNF CU node 228.

In some implementations, TestController 216 is a cloud native Telco test engine, and is a custom resource definition (CRD) controller in the container orchestration platform. TestController 216 can be used to watch the creation of TcaTestSuite custom resource (CR) file 208, which is a CR file for a 5G radio access network (RAN) validation/benchmarking test suite TcaTestSuite. TcaTestSuite CR file 208 can be defined and submitted to k8s cluster 230 directly by the test system TestNF. TestController 216 can also be used to execute test cases using tools in an accessible and non-destructive manner for evaluation of the states in k8s cluster 230.

In some implementations, TcaTestSuite can be used to define TestNF DU pod 212, TestNF CU pod 214, Test DU node 226, TestNF CU node 228, verification intent of cell site host, performance test intent of TestNF DU pod 212 to TestNF CU pod 214, and performance test intent of TestNF DU pod 212 to external testing tools 210. External testing tools 210 can include, for example, simulators and tools for 5G RAN testing.

In some implementations, TcaTestSuite supports several example test cases for 5G RAN validation, as shown in Table 1 below. These test cases include 5G RAN validation at pod level, node level, virtual machine (VM) level, and host level. The test cases may also include performance validation.

TABLE 1

| | | | | |
|---|---|---|---|---|
| Pod level validation | Node level validation | VM level validation | Host level validation | Performance validation |
| antrea/calico managed network. | Linux kernel module customization such as igb_uio, vfio-pci. | CPU/memory pinning with NUMA aware. | BIOS customization : for Flexran, etc | pod to pod traffic (e.g. DU pod to CU pod) over SRIOV device, vmxnet3 ! device, multus CNI, ipvlan, macvlan, sbr, tuning, etc. |
| multus networks and ipvlan, macvlan, SRIOV, tuning, whereabouts, host-local, static CNIs. | CNI binaries. | CPU/memory reservation. | Firmware for accelerator card | External testing ! tool to pod. |
| igb_uio dpdk binding. | File injection. | vfio-pci related vmx setting. | ESXi Driver for accelerator card | Benchmark tools such as pktgen, testpmd, ! cyclic test, Intel FlexRAN L1/L2 \| test. |
| vfio-pci dpdk binding. | Custom packages. | PTP passthrough device. | SRIOV enablement in vmnic | |
| linux kernel and arguments customization. | PTP nic and service automation. | | | |
| | Guest OS drivers such as iavf, ice, i40e | | | |

In some implementations, the above example test cases are defined in TcaTestSuite CR 208 and applied to k8s cluster 230, for example, through NF post instantiation workflow. TcaTestSuite CR 208 may include multiple test cases which are designed for the validation items listed in Table 1 above. The file below shows an example TcaTestSuite CR 208 that includes three parts: the metadata used to define the test suite name, the spec used to define the test cases such as node verification, pod verification, VM verification, and host verification described in Table 1 above, and the status used to represent the test execution result.

```
apiVersion: acm.vmware.com/v1alpha1
kind: TcaTestSuite
metadata:
  name: <test-suite-name>
spec:
  test_cases:
    - name: Verify linux kernel
    type: NODE
    filters:
    - label: testnf-du
  commands:
    -uname -r | grep “^4.19.132-.*-1.ph3-rt$”
  - ...
status:
  test_summary:
    overall status: FAIL
    total: 6
    pass: 4
  fail: 1
  skip: 1
  test_case_outputs:
  - name: Verify linux kernel
  status: PASS
  output: 4.19. 132-rt59-1.ph3-rt
  - ...
```

FIG. 2 also shows that in some implementations, how TestController 216 manages pods that run test cases. For example, four pluggable worker nodes in k8s cluster 230, i.e. TestRunner 218, 220, 222, and 224, are invoked by TestController 216 to select target pods and external testing tools, and perform pod level verification, node level verification, and traffic test. As shown in FIG. 2, TestRunner 218 performs traffic test between external testing tools 210 and TestNF DU pod 212, TestRunner 220 performs pod level verification of TestNF DU pod 212, TestRunner 222 performs traffic test between TestNF DU pod 212 and TestNF CU pod 214, and TestRunner 224 performs node level verification of TestNF CU node 228.

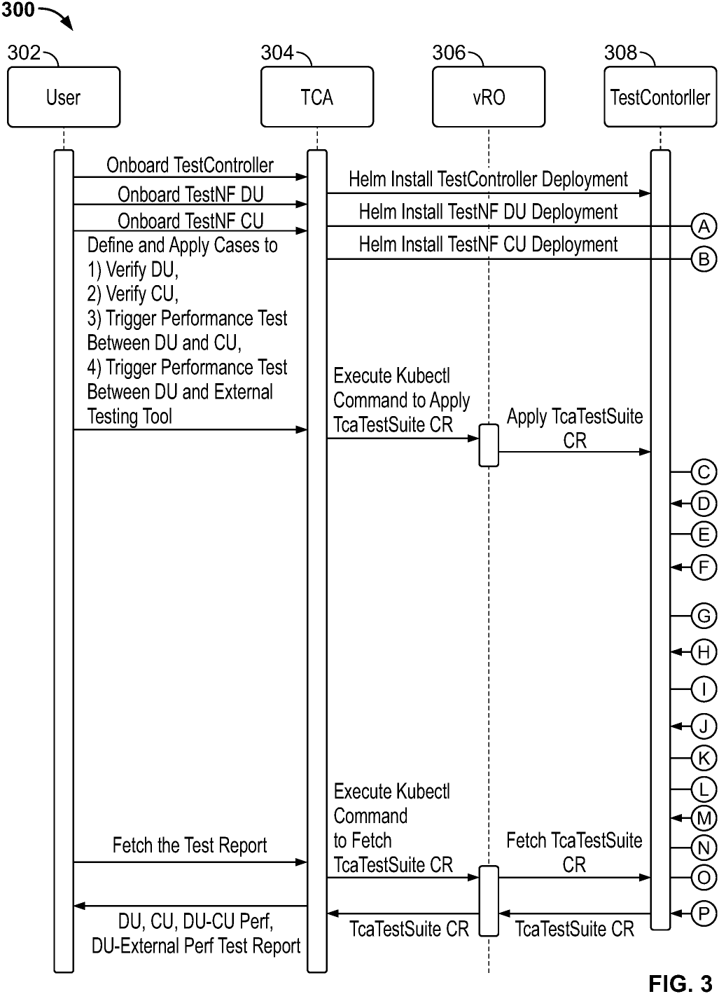

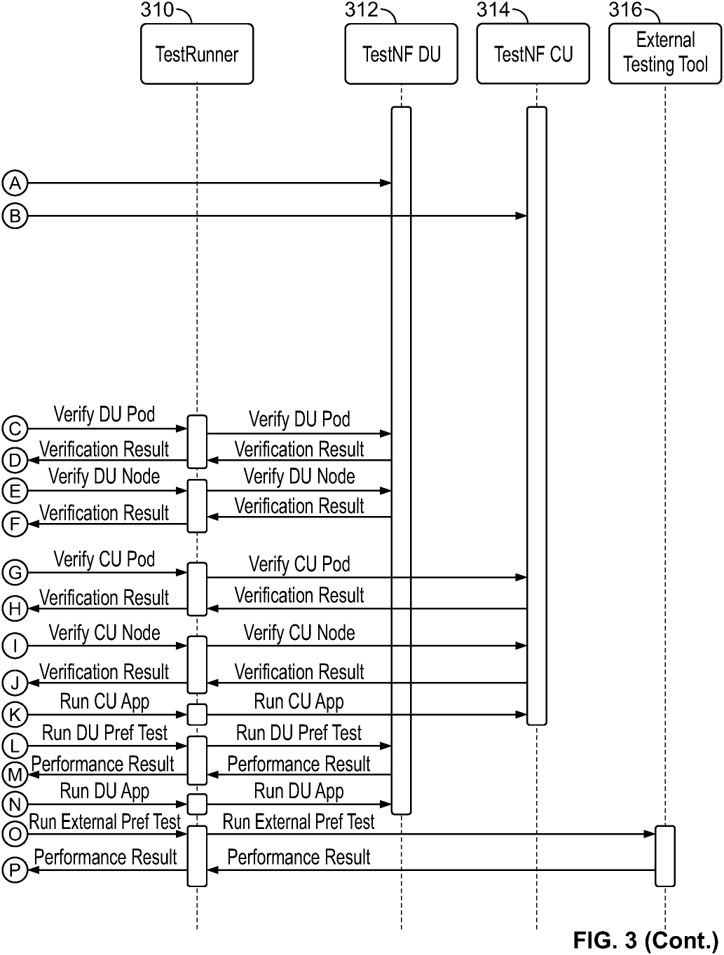

FIG. 3 illustrates an example sequencing diagram 300 for implementing a pluggable diagnostic tool for Telco RAN troubleshooting, in accordance with another example implementation of this disclosure. It shows an example flow of steps involved in 5G RAN validation using the TestNF framework shown in FIG. 2.

In some implementations, a user 302 communicates with TCA 304 to initiate the process of onboarding TestController 308, TestNF DU 312, and TestNF CU 314. Test cases are also defined to verify TestNF DU 312 and TestNF CU 314, trigger performance test (e.g., traffic test) between TestNF DU 312 and TestNF CU 314, and trigger performance test (e.g., traffic test) between TestNF DU 312 and external testing tool 316.

In some implementations, application configurations (e.g., helm chart in k8s) are then deployed by TCA 304 for TestController 308, TestNF DU 312, and TestNF CU 314.

In some implementations, TcaTestSuite CR file is then applied to TestController 308 through a workflow automation platform, for example, a vRealize Orchestrator (vRO) 306.

In some implementations, TestController 308 in turn instructs TestRunner 310, a worker node in a container orchestration platform, to carry out test cases specified in TcaTestSuite CR file. The test cases include verifying TestNF DU pod and DU node in TestNF DU 312, TestNF CU pod and CU node in TestNF CU 314, running DU and CU applications, running performance test between TestNF DU 312 and TestNF CU 314, and running performance test between TestNF DU 312 and external testing tool 316.

In some implementations, Performance test results are then returned from TestNF DU 312, TestNF CU 314, and external testing tool 316 respectively through TestRunner 310 and TestController 308 to update TcaTestSuite CR file, and the updated tcaTestSuite CR file is returned through TCA 304 to user 302 in response to the user’s request to fetch the performance test results.

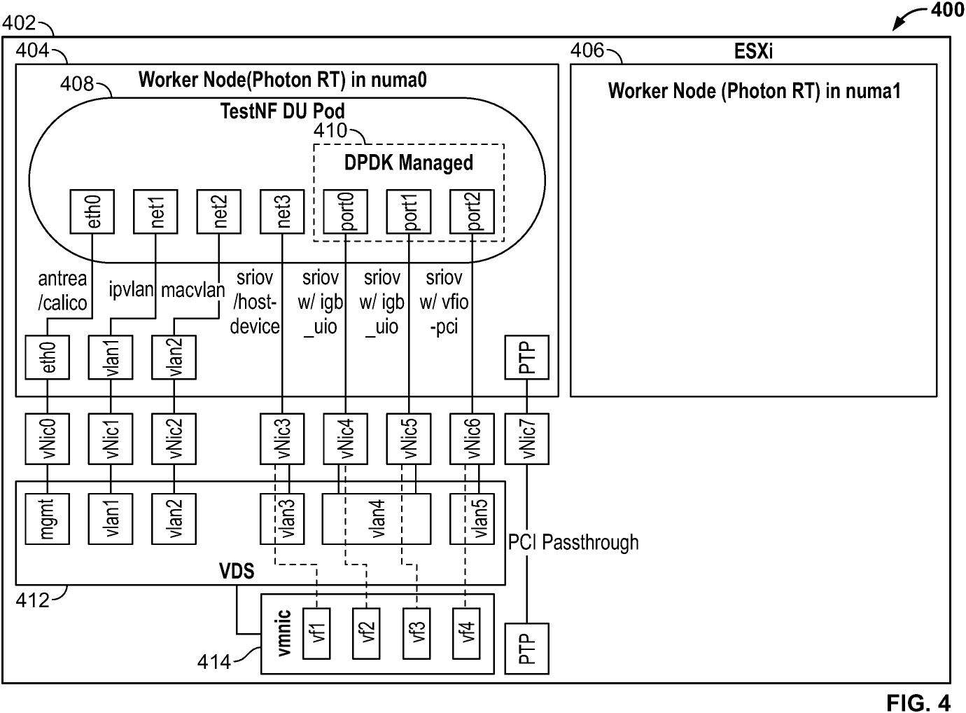

FIG. 4 illustrates an example network topology 400 for implementing a pluggable diagnostic tool for Telco RAN troubleshooting, in accordance with a further example implementation of this disclosure. Network topology 400 has several components as described below.

In some implementations, worker node 404 in a cell site host ESXi 402 is a node in a container orchestration platform and is in virtual machine (VM) form factor with real-time kernel. CPU and memories are pinned to the same NUMA, and PTP PCI device is bypassed to worker node 404.

In some implementations, TestNF DU Pod 408 is used to simulate a DU CNF pod. In one example, it has multiple network interfaces which are managed by linux kernel as follows: eth0 is managed by antrea or calico CNI, net1 is managed by multus with ipvlan plugin, net2 is managed by multus with macvlan plugin, and net3 is managed by multus with SRIOV or host-device plugin. There are also some network interfaces which are managed by DPDK 410: port0 and port1 are managed by igb_uio, and port2 is managed by vfio-pci.

In some implementations, TestNF DU Pod 408 is a privileged Pod. It can be used to execute test cases and diagnose checkpoints on worker node 404. It can also be used to execute Pod and VM level verifications.

In some implementations, virtual machine access switches, such as VDS 412, can be configured with several port groups. In one example, the port groups include the following: mgmt for management purpose, vlan1 for ipvlan, vlan2 for macvlan, vlan3 for SRIOV pass through, vlan4 for VM NICs which are used for DPDK application with igb_uio binding, and vlan5 for VM NIC which is used for DPDK application with vfio-pci binding.

In some implementations, vmnic 414 includes physical network interface controller (NIC) adapters that can be used as uplink of VDS 412. Vmnic 414 can be configured with SRIOV enabled with VF number setting.

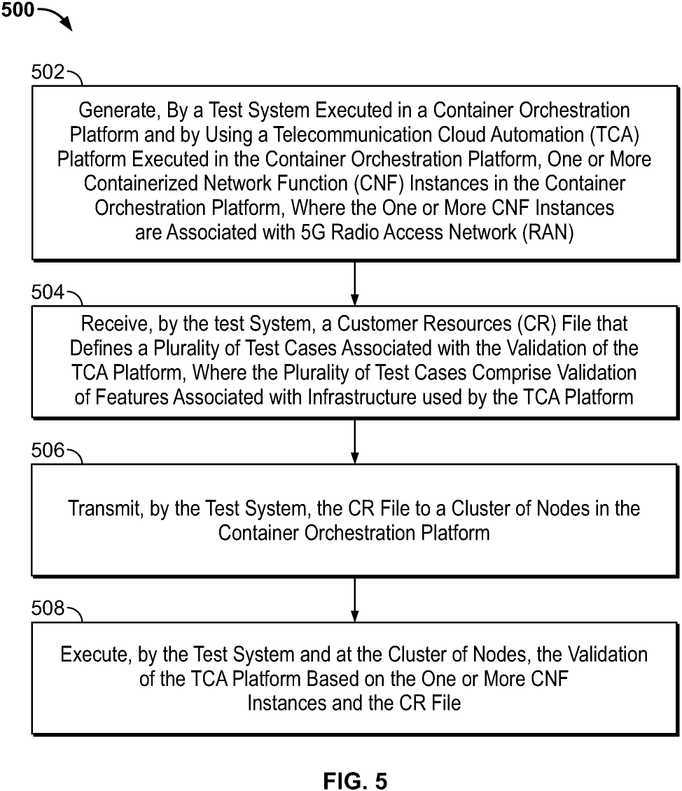

FIG. 5 illustrates an example method for implementing a pluggable diagnostic tool for Telco RAN troubleshooting, in accordance with example implementations of this disclosure.

At 502, a computer system generates, by using a telecommunication cloud automation (TCA) platform executed in a container orchestration platform, one or more containerized network function (CNF) instances in the container orchestration platform, where the one or more CNF instances are associated with 5G radio access network (RAN).

At 504, the computer system receives a customer resources (CR) file that defines a plurality of test cases associated with the validation of the TCA platform, where the plurality of test cases include validation of features associated with infrastructure used by the TCA platform.

At 506, the computer system transmits the CR file to a cluster of nodes in the container orchestration platform.

At 508, the computer system executes, at the cluster of nodes, the validation of the TCA platform based on the one or more CNF instances and the CR file.

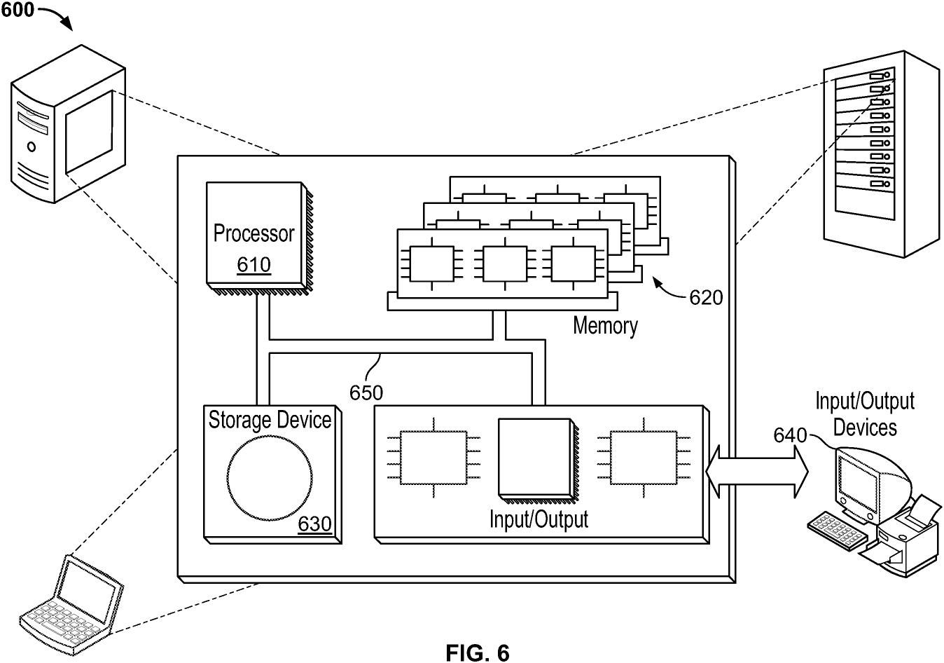

FIG. 6 illustrates a schematic diagram of an example computing system 600. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit. The memory 620 is a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

Certain aspects of the subject matter described here can be implemented as a method. One or more CNF instances in a container orchestration platform are generated by a test system executed in the container orchestration platform and by using a telecommunication cloud automation (TCA) platform executed in the container orchestration platform. The test system is onboarded to the TCAplatform. The test system performs validation of the TCA platform, and the one or more CNF instances are associated with 5G radio access network (RAN). A customer resources (CR) file is received by the test system. The CR file defines a plurality of test cases associated with the validation of the TCA platform. The plurality of test cases include validation of features associated with infrastructure used by the TCA platform. The CR file is transmitted to a cluster of nodes in the container orchestration platform. The validation of the TCA platform is executed by the test system and at the cluster of nodes, based on the one or more CNF instances and the CR file, where the validation is associated with the plurality of test cases.

An aspect taken alone or combinable with any other aspect includes the following features. The generating the one or more CNF instances includes at least one of generating a distributed unit (DU) CNF pod for the test system in a DU node pool in the container orchestration platform, or generating a central unit (CU) CNF pod for the test system in a CU node pool in the container orchestration platform.

An aspect taken alone or combinable with any other aspect includes the following features. A network topology of the test system for the DU CNF pod includes a worker node of the container orchestration platform, a plurality of distributed virtual machine access switches, and a plurality of physical network interface controller (NIC) adapters associated with uplink of the plurality of distributed virtual machine access switches, and where the worker node includes the DU CNF pod.

An aspect taken alone or combinable with any other aspect includes the following features. The executing the validation of the TCA platform includes testing traffic between the DU CNF pod and the CU CNF pod at one or more checkpoints of one or more of the plurality of test cases for exit code corresponding to successful validation of the TCA platform The DU CNF pod and the CU CNF pod run the one or more of the plurality of test cases.

An aspect taken alone or combinable with any other aspect includes the following features. The plurality of test cases include at least one of pod level validation, node level validation, virtual machine (VM) level validation, host level validation, or performance validation.

An aspect taken alone or combinable with any other aspect includes the following features. The node level validation includes validation of at least one of customization of operating system kernel module, file injection, or custom packages. The host level validation includes validation of at least one of customization of basis input/output system (BIOS), firmware for accelerator card, or enablement of single root input/output virtualization (SRIOV) in virtual machine network interface controller (VMNIC).

An aspect taken alone or combinable with any other aspect includes the following features. The test system includes a test controller that controls workflow associated with the validation of the TCA platform.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method, comprising:
generating, by a test system executed in a container orchestration platform and by using a telecommunication cloud automation (TCA) platform executed in the container orchestration platform, one or more containerized network function (CNF) instances in the container orchestration platform, wherein the test system is onboarded to the TCA platform, wherein the test system performs validation of the TCA platform, and wherein the one or more CNF instances are associated with 5G radio access network (RAN);
receiving, by the test system, a customer resources (CR) file, wherein the CR file defines a plurality of test cases associated with the validation of the TCA platform, and wherein the plurality of test cases comprise validation of features associated with infrastructure used by the TCA platform;
transmitting, by the test system, the CR file to a cluster of nodes in the container orchestration platform; and
executing, by the test system and at the cluster of nodes, the validation of the TCA platform based on the one or more CNF instances and the CR file, wherein the validation is associated with the plurality of test cases.

2. The computer-implemented method according to claim 1, wherein generating the one or more CNF instances comprises at least one of:
generating a distributed unit (DU) CNF pod for the test system in a DU node pool in the container orchestration platform, or
generating a central unit (CU) CNF pod for the test system in a CU node pool in the container orchestration platform.

3. The computer-implemented method according to claim 2, wherein a network topology of the test system for the DU CNF pod comprises a worker node of the container orchestration platform, a plurality of distributed virtual machine access switches, and a plurality of physical network interface controller (NIC) adapters associated with uplink of the plurality of distributed virtual machine access switches, and wherein the worker node comprises the DU CNF pod.

4. The computer-implemented method according to claim 2, wherein executing the validation of the TCA platform comprises:
testing traffic between the DU CNF pod and the CU CNF pod at one or more checkpoints of one or more of the plurality of test cases for exit code corresponding to successful validation of the TCA platform, wherein the DU CNF pod and the CU CNF pod run the one or more of the plurality of test cases.

5. The computer-implemented method according to claim 1, wherein the plurality of test cases comprise at least one of pod level validation, node level validation, virtual machine (VM) level validation, host level validation, or performance validation.

6. The computer-implemented method according to claim 5, wherein the node level validation comprises validation of at least one of customization of operating system kernel module, file injection, or custom packages, and wherein the host level validation comprises validation of at least one of customization of basis input/output system (BIOS), firmware for accelerator card, or enablement of single root input/output virtualization (SRIOV) in virtual machine network interface controller (VMNIC).

7. The computer-implemented method according to claim 1, wherein the test system comprises a test controller that controls workflow associated with the validation of the TCA platform.

8. A non-transitory, computer-readable medium storing one or more instructions executable by a computer system to perform operations, the operations comprising:
generating, by a test system executed in a container orchestration platform and by using a telecommunication cloud automation (TCA) platform executed in the container orchestration platform, one or more containerized network function (CNF) instances in the container orchestration platform, wherein the test system is onboarded to the TCA platform, wherein the test system performs validation of the TCA platform, and wherein the one or more CNF instances are associated with 5G radio access network (RAN);
receiving, by the test system, a customer resources (CR) file, wherein the CR file defines a plurality of test cases associated with the validation of the TCA platform, and wherein the plurality of test cases comprise validation of features associated with infrastructure used by the TCA platform;
transmitting, by the test system, the CR file to a cluster of nodes in the container orchestration platform; and
executing, by the test system and at the cluster of nodes, the validation of the TCA platform based on the one or more CNF instances and the CR file, wherein the validation is associated with the plurality of test cases.

9. The non-transitory, computer-readable medium according to claim 8, wherein generating the one or more CNF instances comprises at least one of:
generating a distributed unit (DU) CNF pod for the test system in a DU node pool in the container orchestration platform, or
generating a central unit (CU) CNF pod for the test system in a CU node pool in the container orchestration platform.

10. The non-transitory, computer-readable medium according to claim 9, wherein a network topology of the test system for the DU CNF pod comprises a worker node of the container orchestration platform, a plurality of distributed virtual machine access switches, and a plurality of physical network interface controller (NIC) adapters associated with uplink of the plurality of distributed virtual machine access switches, and wherein the worker node comprises the DU CNF pod.

11. The non-transitory, computer-readable medium according to claim 9, wherein executing the validation of the TCA platform comprises:
testing traffic between the DU CNF pod and the CU CNF pod at one or more checkpoints of one or more of the plurality of test cases for exit code corresponding to successful validation of the TCA platform, wherein the DU CNF pod and the CU CNF pod run the one or more of the plurality of test cases.

12. The non-transitory, computer-readable medium according to claim 8, wherein the plurality of test cases comprise at least one of pod level validation, node level validation, virtual machine (VM) level validation, host level validation, or performance validation.

13. The non-transitory, computer-readable medium according to claim 12, wherein the node level validation comprises validation of at least one of customization of operating system kernel module, file injection, or custom packages, and wherein the host level validation comprises validation of at least one of customization of basis input/output system (BIOS), firmware for accelerator card, or enablement of single root input/output virtualization (SRIOV) in virtual machine network interface controller (VMNIC).

14. The non-transitory, computer-readable medium according to claim 8, wherein the test system comprises a test controller that controls workflow associated with the validation of the TCA platform.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, the one or more operations comprising:
generating, by a test system executed in a container orchestration platform and by using a telecommunication cloud automation (TCA) platform executed in the container orchestration platform, one or more containerized network function (CNF) instances in the container orchestration platform, wherein the test system is onboarded to the TCA platform, wherein the test system performs validation of the TCA platform, and wherein the one or more CNF instances are associated with 5G radio access network (RAN);
receiving, by the test system, a customer resources (CR) file, wherein the CR file defines a plurality of test cases associated with the validation of the TCA platform, and wherein the plurality of test cases comprise validation of features associated with infrastructure used by the TCA platform;
transmitting, by the test system, the CR file to a cluster of nodes in the container orchestration platform; and
executing, by the test system and at the cluster of nodes, the validation of the TCA platform based on the one or more CNF instances and the CR file, wherein the validation is associated with the plurality of test cases.

16. The computer-implemented system according to claim 15, wherein generating the one or more CNF instances comprises at least one of:
generating a distributed unit (DU) CNF pod for the test system in a DU node pool in the container orchestration platform, or
generating a central unit (CU) CNF pod for the test system in a CU node pool in the container orchestration platform.

17. The computer-implemented system according to claim 16, wherein a network topology of the test system for the DU CNF pod comprises a worker node of the container orchestration platform, a plurality of distributed virtual machine access switches, and a plurality of physical network interface controller (NIC) adapters associated with uplink of the plurality of distributed virtual machine access switches, and wherein the worker node comprises the DU CNF pod.

18. The computer-implemented system according to claim 16, wherein executing the validation of the TCA platform comprises:
testing traffic between the DU CNF pod and the CU CNF pod at one or more checkpoints of one or more of the plurality of test cases for exit code corresponding to successful validation of the TCA platform, wherein the DU CNF pod and the CU CNF pod run the one or more of the plurality of test cases.

19. The computer-implemented system according to claim 15, wherein the plurality of test cases comprise at least one of pod level validation, node level validation, virtual machine (VM) level validation, host level validation, or performance validation.

20. The computer-implemented system according to claim 19, wherein the node level validation comprises validation of at least one of customization of operating system kernel module, file injection, or custom packages, and wherein the host level validation comprises validation of at least one of customization of basis input/output system (BIOS), firmware for accelerator card, or enablement of single root input/output virtualization (SRIOV) in virtual machine network interface controller (VMNIC).
